(19) United States
(12) Patent Application Publication
(10) Pub. No.: US 2018/0326430 A1
(43) Pub. Date: Nov. 15, 2018

(54) REMOVING ULTRAFINE PARTICLES FROM AN AIR STREAM OF A VEHICULAR AC SYSTEM

(71) Applicant: PARAGON AG, Delbrueck (DE)

(72) Inventor: Ralf MOENKEMOELLER, Bielefeld (DE)

(21) Appl. No.: 15/773,808

(22) PCT Filed: Dec. 7, 2016
(86) PCT No.: PCT/EP2016/002055

§ 371 Date: May 4, 2018

(30) Foreign Application Priority Data
Jan. 15, 2016 (DE) 10 2016 000 385.5

(51) Int. Cl. B03C 3/12; B03C 3/36; B03C 3/41; B03C 3/45; B03C 3/78; B60H 3/00; B60H 3/06

(52) U.S. Cl. CPC B03C 3/12; B03C 3/368; B03C 3/41; B03C 2201/30; B03C 3/78; B60H 3/0078; B60H 3/0633; B03C 3/455

(57) ABSTRACT

In order, in the case of a device for separating ultra-fine particles (UFP) from an air flow (3) which flows in motor vehicle ventilation and climate control systems (1), to ensure a higher degree of separation for said ultra-fine particles (UFP), it is proposed that the device for separation is configured as an electrostatic separation device (8), having a collecting electrode (11), on which ultra-fine particles can be accumulated which are charged in the electrostatic separation device (8) upstream in the flow direction of the air flow (3), and that the collecting electrode (11) of the electrostatic separation device (8) is arranged in relation to an evaporator (5) of the motor vehicle ventilation and climate control system (1) in such a way that the collecting electrode (11) can be cleaned automatically by means of condensation water which is produced on the evaporator (5).

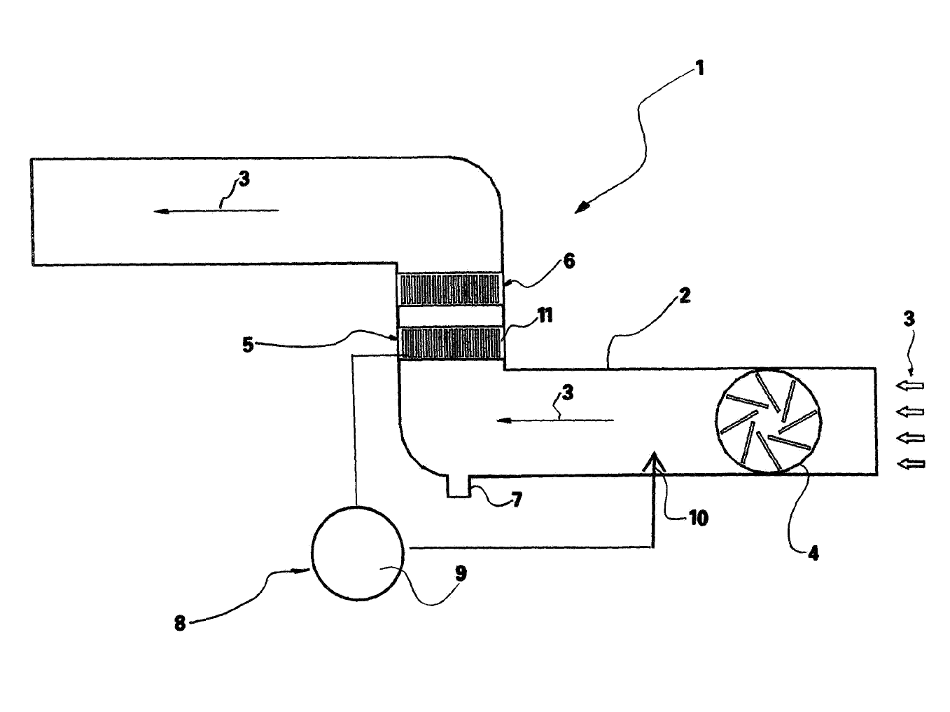

The invention relates to an apparatus for separating ultrafine particles (UFP) from an air stream flowing in a motor-vehicle ventilation and climate-control system.

It is known that fine particles is harmful to health. The finer these particles are, the greater the likelihood they may settle in the lungs of vehicle occupants and cause serious illness.

In response to this threat, vehicle manufacturers have been equipping their motor vehicles with constantly improving filters for some time to prevent these fine particles from getting into the motor vehicle interior. Most of these filters are also installed in the motor-vehicle ventilation and climate-control system in such a way that even in recirculated air mode the air stream passes through this filter multiple times. This ensures that, when the vehicle ventilation and climate-control system is in recirculated air mode, more and more fine particles of this kind are separated out of the air stream as time goes on.

However, the conventionally used filters and fine particles filters are associated with significant deficiencies in terms of separating ultrafine particles (UFP). Their separation efficiency in respect of these ultrafine particles (UFP) is comparatively low. This separation efficiency can only be increased if a relatively large loss of pressure is accepted.

From industrial processes it is known to filter ultrafine particles (UFP) out of an air stream using electrostatic precipitator. To this end, electrostatic precipitators are used that operate in two stages. In a first stage, the ultrafine particles (UFP) are ionized by corona discharge, using discharge electrodes as well, for example. This causes the ultrafine particles (UFP) to become electrically charged.

In a second stage of the electrostatic precipitator, the particles that have been electrically charged as described above pass through an electrode arrangement that is electrically charged in such manner that the charged dust particles accumulate on this electrode arrangement or the separation electrode due to the electrical forces.

Electrostatic precipitators have not gained widespread acceptance in the field of a motor-vehicle ventilation and climate-control system because of certain adverse aspects that will be explained in the following. Firstly, the installation space in the area of a motor-vehicle ventilation and climate-control system in modern motor vehicles is so limited that integration of an electrostatic precipitator entails considerable difficulty. Another problem that has not been solved is the question of servicing an electrostatic precipitator. The dust particles that have accumulated on such an electrostatic precipitator must be removed from it regularly in order to keep the electrostatic precipitator running smoothly. Such a regular removal of accumulated dust particles runs counter to the fundamental efforts by vehicle manufacturers to make maintenance intervals for motor vehicles longer and longer. The automatic cleaning systems for such electrostatic precipitators known from industrial processes are unwelcome in a motor vehicle and are also not practicable due to the technical and financial costs they entail.

Starting from the related art as described above, the object underlying the invention is to provide an apparatus for separating ultrafine particles (UFP) from an air stream that flows in a motor-vehicle ventilation and climate-control system, with which a significant increased in separation efficiency of ultrafine particles (UFP) may be achieved and greater loss of pressure inside the motor-vehicle ventilation and climate-control system may be avoided at the cost of a reasonable amount of design engineering and financial outlay.

This object is solved according to the invention by configuring the apparatus for separating ultrafine particles (UFP) as an electrostatic precipitator with a collecting electrode, on which ultrafine particles can be accumulated that are charged in the electrostatic precipitator upstream in the flow direction of the air stream, and arranging the collecting electrode of the electrostatic precipitator in such manner relative to an evaporator of the motor-vehicle ventilation and climate-control system that the collecting electrode may be cleaned automatically by condensate water that forms on the evaporator. It is thus provided according to the invention to use the condensate water present on the evaporator for cleaning the collecting electrode. The evaporator that is present in all known a motor-vehicle ventilation and climate-control system, cools and dehumidifies the air. If the temperature on the evaporator surface falls below the dew point, which happens regularly in normal operation, moisture condenses on the evaporator surface. According to the invention, the collecting electrode of the electrostatic precipitator is arranged geometrically so that condensate water that forms on the evaporator surface flows down to a drain outlet for the condensate water over the collecting electrode. In this process, fine particles that has accumulated on the collecting electrode is caught up by the condensate water and flushed away with the condensate water. In this way, the collecting electrode arrangement provided according to the invention ensures that the collecting electrode is cleaned regularly without the need to seek out a workshop or specialist company for this purpose.

According to an advantageous further development of the electrostatic precipitator according to the invention, an electrically conductive surface of the evaporator in the motor-vehicle ventilation and climate-control system is the collecting electrode of the electrostatic precipitator. In this way, the evaporator itself is effectively used directly as the collecting electrode. This is possible without major technical structural work since the evaporator surface is typically made from a conductive metal. By this means, it is also possible to solve all of the problems that exist regarding the installation space. With this variant of the electrostatic precipitator according to the invention, it is possible to succeed in integrating an electrostatic precipitator in almost any motor vehicle equipped with a motor-vehicle ventilation and climate-control system.

The electrically conductive surface of the evaporator is advantageously formed by condensate water that has condensed on the surface of the evaporator.

In a further advantageous embodiment of the electrostatic precipitator according to the invention, a high electrical potential may be applied to a heat exchanger of the motor-vehicle ventilation and climate-control system that then functions as an additional separation stage of the electrostatic precipitator.

The heat exchanger that functions as an additional separation stage of the electrostatic precipitator is expediently arranged downstream of the collecting electrode in the direction of flow of the air stream.

The electrostatic precipitator is advantageously equipped with a charging and discharging electrode, by which the ultrafine particles (UFP) present in the air stream may be charged, preferably positively charged, by a corona discharge.

Accordingly, it is expedient if the collecting electrode of the electrostatic precipitator or the evaporator can be charged negatively, wherein charging preferably takes place to a negative level between −20 kV and −50 kV.

The second separation stage or the heat exchanger may expediently be charged with a high electrical potential.

If the second separation stage or the heat exchanger can be charged with a high negative electrical potential and the ultrafine particles (UFP) have been positively charged, further ultrafine particles from the air stream may be captured on the heat exchanger.

If the second separation stage or the heat exchanger and the ultrafine particles are charged with a high positive electrical potential, the heat exchanger constitutes an impassable obstacle for the ultrafine particles due to the effect of the repulsive force.

In the following section, the invention will be explained in greater detail on the basis of an embodiment thereof and with reference to the drawing. The single figure of the drawing shows an embodiment of an apparatus according to the invention for separating ultrafine particles (UFP) from an air stream that flows in a motor-vehicle ventilation and climate-control system.

The single figure represents a cross section of the part of a typical motor-vehicle ventilation and climate-control system that is essential for the present invention installed in a modern motor vehicle.

This motor-vehicle ventilation and climate-control system 1 includes an air duct 2 through which an air stream 3 is guided and introduced into a vehicle interior that is not shown in the figure. Air stream 3 may be generated and maintained by a fan 4 inside air duct 2.

An evaporator 5 and a heat exchanger 6 of a heater system of the motor-vehicle ventilation and climate-control system 1 are provided downstream of fan 4 in air duct 2 of the motor-vehicle ventilation and climate-control system 1, and an air stream 3 is moved past these, propelled through air duct 2 by fan 4.

Air stream 3 is cooled and dehumidified by the evaporator 5 of the motor-vehicle ventilation and climate-control system 1. In this process, moisture condenses on the evaporator surface when the temperature thereof falls below the dew point. This occurs regularly during normal operation of the motor-vehicle ventilation and climate-control system 1. A drain outlet 7 for condensed water is provided underneath the evaporator 5 to drain the precipitated moisture on the evaporator surface and the condensate water resulting therefrom out of the motor-vehicle ventilation and climate-control system 1.

An apparatus for separating ultrafine particles (UFP) from the air stream 3 flowing through the air duct 2 is integrated in the motor-vehicle ventilation and climate-control system 1, of which the part that is essential for the purposes of the present invention is represented in cross section in the single figure. For the purposes of the invention, this apparatus for separating ultrafine particles (UFP) is designed as electrostatic precipitator 8. This electrostatic precipitator 8 includes a voltage source 9, by which a charging and discharging electrode 10—represented in the figure only by an arrow—may be supplied with electrical energy. Dust particles—including ultrafine particles (UFP)-present in the air stream 3 are ionized by the charging and discharging electrode 10, for example by a corona discharge, causing them to become electrically charged.

The electrostatic precipitator 8 further includes a collecting and separation electrode 11 that can be charged by the voltage source 9 in such manner that the dust particles that are charged in the charging and discharging electrode 10 of the electrostatic precipitator 8 arranged upstream of the collecting and separation electrode 11 in the flow direction of the air stream 3 accumulate at the collecting and separation electrode 11 due to the effect of electrical forces.

The essential feature in the case of the electrostatic precipitator 8 according to the invention for separating ultrafine particles (UFP) from the air stream 3 flowing through the air duct 2 is that the condensate water that forms on the evaporator 5 of the motor-vehicle ventilation and climate-control system 1 may be used for cleaning the collecting and separation electrode 11.

To do this, all that is actually necessary it to arrange the collecting and separation electrode 11 geometrically and spatially in such manner that the condensate water that collects on the evaporator 5 flows over the collecting and separation electrode 11 on its way to the drain outlet 7 and in so doing picks up, traps and washes away the fine particles that have accumulated there. With such an arrangement of the collecting and separation electrode 11 it is assured that the collecting and separation electrode 11 is cleaned regularly during normal operation of the motor-vehicle ventilation and climate-control system 1 without the need to visit a specialized operator or workshop with the vehicle.

In the embodiment of the electrostatic precipitator 8 according to the invention shown in the single figure, the collecting and separation electrode 11 thereof is formed by the evaporator surface of the evaporator 5 itself, which is usually made of a conductive metal that can be electrically charged by the voltage source 9.

Consequently, now additional stowage space of any kind is needed for the collecting and separation electrode 11 of the electrostatic precipitator 8. Practically every motor vehicle that is equipped with motor-vehicle ventilation and climate-control system 1 may be equipped correspondingly with the electrostatic precipitator 8.

When the electrostatic precipitator 8 is operating, even ultrafine particles present in the air stream 3 are electrically charged—by corona discharge for example—by the charging and discharging electrode 10 arranged downstream of the fan 4 in the flow direction of the air stream 3 in the embodiment shown in the single figure.

In this context, said particles may be charged either positively or negatively. As a rule the particles are charged positively, as also in the case of the electrostatic precipitator 8 shown in the single figure, since the arcing voltage at the charging and discharging electrodes 10 is then considerably higher than the arcing voltage at technically comparable, negatively charged charging and discharging electrodes 10.

To ensure that the particles that are charged by the charging and discharging electrode 10 are separated from the air stream 3 and attracted to stick by the collecting and separation electrode 11 in the form of the evaporator surface of the evaporator 5, the collecting and separation electrode 11 that is formed by an evaporator surface of the evaporator 5 made from an electrically conductive material must be charged by the voltage source with an electrical potential that is opposite to that of the particles. If the particles have been charted positively, as described previously, the evaporator surface must accordingly be charged negatively as strongly as possible, so that an attractive force sufficient to attract and hold is exerted on the positively charged particles in the air stream 3.

In the embodiment of the electrostatic precipitator 8 according to the invention shown in the single figure, the evaporator surface that forms the collecting and separation electrode 11 is charged to a an electrical potential between −20 kV and −50 kV. A still stronger electrical potential would be advantageous, but would only be manageable with significant extra structural and technical effort, since the risk of electrical arcs increases disproportionally with a stronger negative potential.

As a rule, cooling agent lines are connected in electrically conductive manner with the evaporator 5. If the evaporator surface is charged heavily, the evaporator 5 must be insulated electrically from the rest of the motor vehicle and the motor-vehicle ventilation and climate-control system 1.

The evaporator surface of the evaporator 5 is cleaned regularly when condensate water present on the evaporator surface, in which the particles collect runs of down the evaporator surface to the drain outlet 7, taking the particles with it.

A further improvement to the electrostatic precipitator 8 according to the invention is realized if the heat exchanger 6 of the heater system din the motor-vehicle ventilation and climate-control system 1, which is always arranged downstream of the evaporator 5 in the direction of flow of the air stream 3, is also charged with an electrical potential.

With such a design of the heat exchanger 6, two different approaches are opened for consideration.

According to the first approach, the heat exchanger 6 is charged with the same polarity as the particles. For tiny, ultrafine particles that are transported past the evaporator 5 with the air stream 3, the repulsion forces exerted by the heat exchanger 6 then represent a impassable obstacle.

According to the second approach, the heat exchanger 6 is charged with a polarity opposite to that of the particles. Tiny, ultrafine particles that are transported past the evaporator 5 with the air stream 3 then accumulate on the heat exchanger 6.

1. An apparatus for separating ultrafine particles from an air stream flowing in a motor-vehicle ventilation and climate-control system, wherein the apparatus for separating is an electrostatic precipitator, with a collecting electrode on which ultrafine particles that have been charged in the electrostatic precipitator upstream in the direction of flow of the air stream can accumulate, and that the collecting electrode of the electrostatic precipitator is arranged relative to an evaporator of the motor vehicle ventilation and climate control system in such manner that the collecting electrode can be cleaned automatically by condensate water that forms on the evaporator.

2. The apparatus according to claim 1, wherein an electrically conductive surface of the evaporator of the motor vehicle ventilation and climate control system is a collecting electrode of the electrostatic precipitator.

3. The apparatus according to claim 2, wherein the electrically conductive surface of the evaporator is formed by condensate water that has precipitated on the surface of the evaporator.

4. The apparatus according claim 1, further comprising:
a heat exchanger of the motor vehicle ventilation and climate control system can be charged with a high electrical potential and is an additional separation stage of the electrostatic precipitator.

5. The apparatus according to claim 4, wherein the heat exchanger is downstream of the collecting electrode in the direction of flow of the air stream as an additional separation stage of the electrostatic precipitator.

6. The apparatus according to claim 1, wherein the electrostatic precipitator includes a charging and discharging electrode that charges the ultrafine particles present in the air stream.

7. The apparatus according to claim 1, wherein the collecting electrode and/or the evaporator can be charged negatively.

8. The apparatus according to claim 1, wherein the second separation stage and/or the heat exchanger can be charged with a high electrical potential.

9. The apparatus according to claim 4, wherein the second separation stage and/or the heat exchanger can be charged with a high negative electrical potential.

10. The apparatus according to claim 4, wherein the second separation stage and/or the heat exchanger can be charged with a high positive electrical potential.

11. In a motor vehicle, the combination of:
a duct;
a blower for passing an air stream in a flow direction through the duct;
an evaporator for contact cooling the air stream and thereby condensing water from the air stream onto a surface of the evaporator;
a drain in the duct below the evaporator for conducting out of the duct the water condensed onto the surface from the air stream and dripping down off the surface; and
an electrostatic precipitator including
a corona-discharge electrode in the duct upstream in the direction from the evaporator for imparting a charge to particles in the air stream, and
an oppositely charged electrode on the evaporator for attracting particles in the air stream charged by the corona-discharge electrode and for pulling the particles electrostatically into the condensate water that then drops down and passes out of the duct through the drain.

12. The combination defined in claim 11, wherein the water condensed onto the evaporator forms at least part of the condensing electrode.

13. The combination defined in claim 11, further comprising:
a heat exchanger downstream in the flow direction from the evaporator and connected to the electrostatic precipitator as another electrode for trapping particles in the air stream that pass through the evaporator.

14. The combination defined in claim 11, wherein the flow direction is vertical through the evaporator and the drain is directly below the evaporator.
